(19) United States
(12) Patent Application Publication
(10) Pub. No.: US 2026/0278746 A1
(43) Pub. Date: Sep. 17, 2026

(54) SYSTEMS AND METHODS FOR SIMULATING SKIN MODIFICATIONS

(71) Applicant: HautAI OU, Tallinn (EE)

(72) Inventors: Anastasia Georgievskaya, Tallinn (EE); Konstantin Kiselev, Tallinn (EE); Timur Tlyachev, Tallinn (EE); Arseniy Golodyayev, Tallinn (EE); Daniil Danko, Tallinn (EE)

(73) Assignee: HautAI OU, Tallinn (EE)

(21) Appl. No.: 19/566,884

(22) Filed: Mar. 13, 2026

Related U.S. Application Data
(60) Provisional application No. 63/772,678, filed on Mar. 16, 2025.

(51) Int. Cl. G06T 5/60; G06F 3/04845; G06T 7/00

(52) U.S. Cl. CPC G06T 5/60; G06F 3/04845; G06T 7/0012; G06T 2207/30036; G06T 2207/30088

(57) ABSTRACT

A method for simulating modifications to a dermal region in an image includes receiving the image that includes the dermal region. The method further includes identifying a target modification to apply to the dermal region in the image. The method further includes retrieving a dermal change function associated with the target modification. The method further includes locating at least one area of the image containing the dermal region. The method further includes adjusting the image by applying the dermal change function to the at least one area of the image containing the dermal region to achieve the target modification. The method further includes outputting the adjusted image with the target modifications applied to the dermal region.

### PRIORITY CLAIM

This application claims the benefit and priority of U.S. Provisional Patent Application No. 63/772,678, titled SYSTEMS AND METHODS FOR SIMULATING SKIN MODIFICATIONS and filed on Mar. 16, 2025, the entire contents of which is hereby incorporated by reference.

### BACKGROUND

### 1.Field

The present disclosure relates to computer vision and machine-learning algorithm-based image processing and skin analysis, and more particularly, to systems and methods for simulating modifications to dermal regions such as the effects of aging or treatments on skin of various users over time.

### 2. Description of the Related Art

Cosmetics, and skincare in particular, is a large and growing industry. Youthful-looking skin is desirous throughout the world, and people are spending a large and growing sum of money to achieve youthful skin. Aging alone can affect skin by making it thinner, less elastic, and more prone to wrinkles due to decreased collagen and elastin production, and lifestyle can compound these skin effects. For example, a poor diet, dehydration, poor sleep, high stress lifestyle, sun exposure, smoking, and sedentary lifestyle can all accelerate the effects of aging skin, and can even contribute to skin disorders as we age. Accordingly, there are many companies that are investing significant money into research and development for new products and procedures that claim to decelerate or even reverse the effects of aging.

Thousands of such cosmetic products and procedures that claim to slow or reverse the effects of skin aging are currently available, and many more will be available in the coming years. Sellers of these products and procedures all make these claims using similar language and slogans (e.g., “keep youthful skin,” “youthful vitality,” “science-backed beauty,” etc.) that all starts to sound similar after a while. It may be difficult for consumers to visualize the results of these products and procedures, making shopping around for skincare treatments difficult. In addition, although these products and procedures may make broad claims, they may each affect different individuals differently based on the specific parameters of skin for each user.

Thus, there is a need in the art for systems and methods for visually simulating the effects of aging and the long-term effects of use of various products and procedures on skin.

### SUMMARY

The present disclosure provides systems and methods for simulating modifications to a dermal region in an image. The method includes receiving the image that includes the dermal region. The method further includes identifying a target modification to apply to the dermal region in the image. The method further includes retrieving a dermal change function associated with the target modification. The method further includes locating at least one area of the image containing the dermal region. The method further includes adjusting the image by applying the dermal change function to the at least one area of the image containing the dermal region to achieve the target modification. The method further includes outputting the adjusted image with the target modifications applied to the dermal region.

In any of the foregoing embodiments, the dermal region includes at least one of skin, hair, nails, eyelashes, or teeth.

In any of the foregoing embodiments, the image is received from at least one of a mobile device, a professional imaging device, or a macro imaging device.

In any of the foregoing embodiments: the target modification includes a cause of modification and a duration of the cause of the modification; and adjusting the image includes applying the dermal change function for the cause of the modification by an amount that corresponds to the duration of the cause of the modification.

In any of the foregoing embodiments: the target modification includes a magnitude of a cause of the target modification; and adjusting the image includes applying the dermal change function for the cause of the modification by another amount that corresponds to the magnitude of the cause of the modification.

In any of the foregoing embodiments, adjusting the image includes: conditioning a generative artificial intelligence (AI) algorithm with parameters derived from the dermal change function; and using the generative AI algorithm to synthesize at least one of the adjusted image or specific texture details shown in the adjusted image.

Any of the foregoing embodiments may further include: identifying a source anatomical region in the received image corresponding to at least one of a body part shown in the received image or a body part identified by a user; receiving a selection of a target anatomical region that is different from the source anatomical region; mapping the dermal change function from the source anatomical region to the target anatomical region using a cross-domain synthesis algorithm; and generating a new image such that the target modification is rendered on the target anatomical region based on data extracted from the source anatomical region.

In any of the foregoing embodiments, identifying the target modification includes: receiving a natural language textual prompt describing the target modification to be applied to the dermal region; converting the natural language textual prompt into a multimodal embedding using a text encoder algorithm; and deriving the dermal change function at least in part based on the natural language textual prompt and using the multimodal embedding when adjusting the image by applying the dermal change function.

In any of the foregoing embodiments, the received image is associated with light within a first frequency range, and adjusting the image includes: transferring a representation of the dermal region from the first frequency range to a second frequency range, wherein the first frequency range and the second frequency range are different; and adjusting the image further includes outputting information from the second frequency range to illustrate at least one of subsurface, non-visible, or structurally enhanced dermal features corresponding to the target modification

Also disclosed is a method for simulating modifications to a dermal region in an image. The method includes receiving an image that includes the dermal region. The method further includes identifying a target modification to apply to the dermal region in the image, the target modification being associated with at least one of application of a cosmetic product, a wellness procedure, a cosmetic procedure, a medical treatment, or exposure to an environment. The method further includes retrieving a dermal change function associated with the target modification. The method further includes locating at least one area of the image containing the dermal region. The method further includes adjusting the image by applying the dermal change function to the at least one area of the image containing the dermal region to achieve the target modification. The method further includes outputting the adjusted image with the target modifications applied to the dermal region.

Any of the foregoing embodiments may further include: generating descriptive language that describes the dermal change function, the descriptive language describing results of the at least one of the application of the cosmetic product, the medical treatment, or the exposure to the environment; and outputting the descriptive language that describes the dermal change function.

Any of the foregoing embodiments may further include generating a written description of the effects of the cosmetic product, the medical treatment, or the exposure to the environment based on the descriptive language that describes the dermal change function.

In any of the foregoing embodiments, the dermal change function is determined based on at least one of scientific literature, published reports, academic presentations, or medical studies.

Also disclosed is a method for simulating modifications to a dermal region in an image. The method includes receiving an image that includes the dermal region. The method further includes analyzing the image to identify one or more parameters of the dermal region. The method further includes identifying an agent of influence usable to at least one of affect, or reduce the likelihood of progression of, at least one of the one or more identified parameters. The method further includes identifying a target modification to apply to the dermal region in the image, the target modification being associated with application of the agent of influence. The method further includes retrieving a dermal change function associated with the target modification. The method further includes locating at least one area of the image containing the dermal region. The method further includes adjusting the image by applying the dermal change function to the at least one area of the image containing the dermal region to achieve the target modification, such that the adjusted image illustrates results of the application of the agent of influence. The method further includes outputting the adjusted image with the target modifications applied to the dermal region, and outputting an identifier of the agent of influence.

Also disclosed is a method for simulating modifications to a dermal region in an image. The method includes receiving an image that includes the dermal region. The method further includes identifying a target modification to apply to the dermal region in the image. The method further includes determining a dermal change function associated with the target modification using an artificial intelligence (AI) algorithm and based on a measured effect in a controlled or semi-controlled environment. The method further includes locating at least one area of the image containing the dermal region. The method further includes adjusting the image by applying the dermal change function to the at least one area of the image containing the dermal region to achieve the target modification. The method further includes outputting the adjusted image with the target modifications applied to the dermal region.

In any of the foregoing embodiments, the measured effect is determined based on: a first set of images of at least one subject taken at a first point in time; a second set of images of the at least one subject taken at a second point in time that is different than the first point in time; and tags indicating specific modifications applied to the at least one subject between the first point in time and the second point in time.

In any of the foregoing embodiments, the specific modifications correspond to at least one of an application of cosmetic products, a cosmetic procedure, a wellness procedure, a medical treatment, exposure to an environment, or aging.

In any of the foregoing embodiments, the measured effect is determined based on at least one of sensor data or expert annotation data indicating changes in measurements over time that correspond to changes in dermal features.

In any of the foregoing embodiments, the dermal change function is used to at least one of: generate a first set of images illustrating intermediate changes between a first point in time and a second point in time; or generate a second set of images illustrating an effect beyond the second point in time for illustrating evolution of specific modifications.

Any of the foregoing embodiments may further include: identifying product and effect data that includes ingredients of cosmetic products, concentrations thereof in the cosmetic products, and effects associated with the ingredients and the concentrations; receiving new product information corresponding to a new product and including new product ingredients and new concentrations thereof; and predicting a new product modification corresponding to effects of the new product on the dermal region based on the new product information and the product and effect data, wherein the target modification is the new product modification such that the adjusted image corresponds to application of the new product.

Any of the foregoing embodiments may further include generating a written description of the new product modification based on the predicted new product modification.

Any of the foregoing embodiments may further include: generating a set of tags for a new agent of influence, the tags including at least one of: dermal needs addressed by the new agent of influence, product activity and mechanism of effect of the new agent of influence, class solution of the new agent of influence, category of the new agent of influence, or frequency of application of the new agent of influence, and providing recommendations based on the generated set of tags.

Any of the foregoing embodiments may further include: generating a new set of images of at least one of a face, skin, hair, teeth, eyelashes, or nails by applying the dermal change function to a set of base images to transfer a visual representation of dermal effects from a first group of subjects to a second group of subjects shown in the set of base images; and using the new set of images to scale a clinical dataset by showing effects of the dermal change function which illustrates an agent of influence.

Any of the foregoing embodiments may further include generating at least one of: a set of images of a subject of the image that includes the dermal region from different angles, three-dimensional (3D) objects, or videos from the adjusted image with the target modifications applied to the dermal region.

It will be appreciated that features of the present disclosure are susceptible to being combined in various combinations without departing from the scope of the present disclosure as defined by the appended claims.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. Where possible, like reference numerals designate like parts throughout the different views, wherein:

FIG. 1A is a block diagram illustrating a system for simulating modifications to dermal regions in images, according to some embodiments of the present disclosure;

FIG. 1B is a block diagram illustrating components of a device in the system of FIG. 1A, according to some embodiments of the present disclosure;

FIGS. 2A and 2B are flowcharts illustrating a method for simulating modifications to dermal regions in images, according to some embodiments of the present disclosure;

FIG. 3 is a flowchart illustrating a method for analyzing potential products or new products and for generating a dermal change function of the potential products or new products, according to some embodiments of the present disclosure; and

FIG. 4 is a flowchart illustrating a method for training a recommendation algorithm or an algorithm that applies dermal change functions to images based on hypothetical application of products or procedures, according to some embodiments of the present disclosure.

### DETAILED DESCRIPTION OF EMBODIMENTS

The present disclosure describes systems and methods for simulating modifications to dermal regions, such as simulating aging of the dermal region and simulating effects of dermal interventions, dermal treatments, and environmental factors on dermal regions over time. The systems and methods disclosed herein provide significant advantages such as producing images that visually show benefits achieved using certain dermal interventions and treatments, or effects of time under environmental factors or the influence of specific agents. The long-term benefits can even be simulated on images of a potential user’s dermal regions, thus allowing them to understand how they will benefit from use of the interventions and treatments. The systems and methods herein can also advantageously be used to scale clinical datasets, thus increasing ease of completing longer-term studies. The systems and methods can also beneficially be used to make product recommendations for users based on their specific dermal parameters and long-term goals. The systems may also generate language that describes the effects of new skincare treatments and interventions, thus advantageously creating marketing language for brands.

An exemplary system includes a user device that captures or transmits an image (e.g., a photograph) of a user that includes some dermal regions. A processor, such as on the user device or on a server in communication with the user device, may identify a target modification to apply to the dermal region in the image such as application of a certain product over a selected period of time. The processor may also retrieve a dermal change function that is associated with the target modification, locate dermal regions in the image, and adjust the image by applying the dermal change function to the dermal regions in the image. An output device may output the adjusted image that includes the target modification applied to the dermal region.

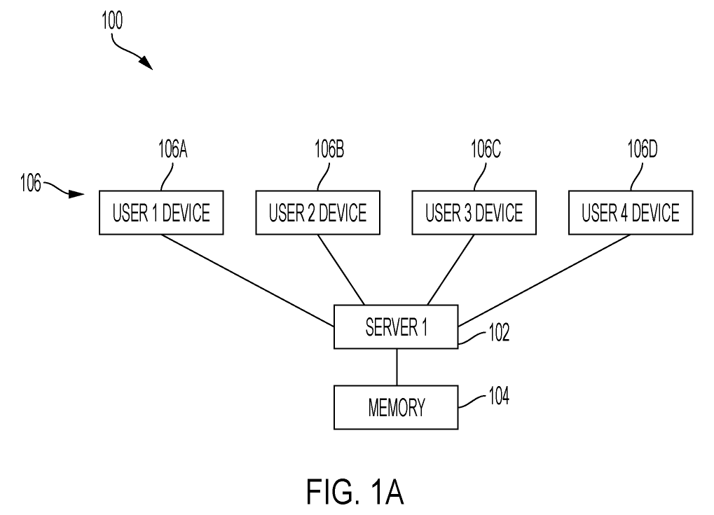

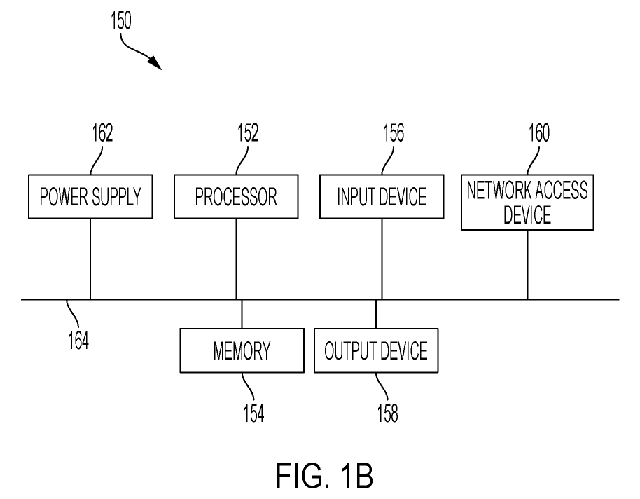

Referring to FIG. 1A, a system 100 for simulating modifications to dermal regions is shown. Throughout the specification, drawings, and claims, “skin” and “dermal region” are used interchangeably. Each of these terms may refer to regions on a living creature that may include at least one of skin, hair (of any sort such as head hair, body hair, eyebrows, eyelashes, etc.), scars, pores, nails, calluses, blood vessels visible on a surface, teeth, or the like. In some embodiments, a dermal region or skin region may include any regions of living tissue that can change over time and are non-identifying.

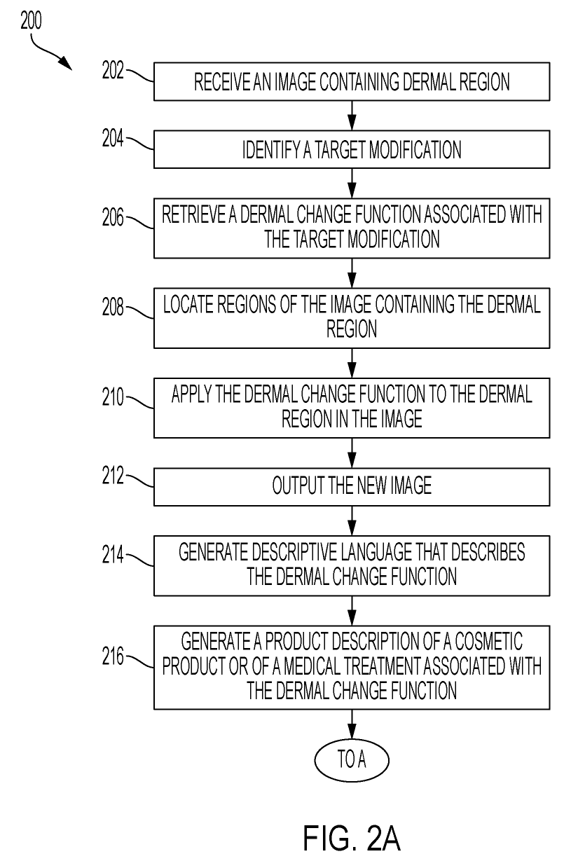

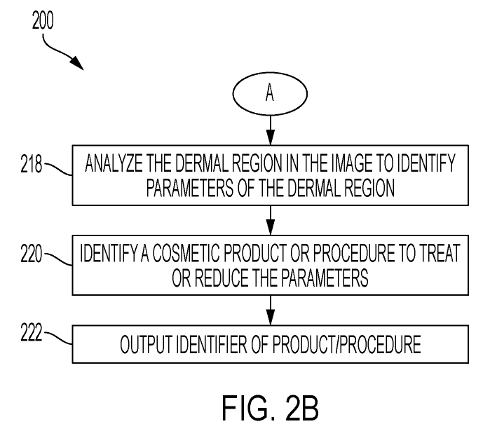

The system 100 may include at least one server 102, at least one memory 104, and at least one user device 106. The specific embodiment illustrated in FIG. 1 includes one server 102, one memory 104, and four user device 106A, 106B, 106C, 106D. Each of the devices may include similar features as the exemplary device 200 shown in FIG. 2 and discussed below. The system 100 may perform any of the methods discussed in detail below regarding simulating modifications to dermal regions, training an artificial intelligence (AI) dermal modification algorithm, recommending new skincare treatments and products, assisting with clinical trials, and describing or summarizing benefits achieved by using certain skincare treatments and products. That is, various components of the server 102, memory 104, and user device 106 may be used to perform any block of any method described herein, and may perform any blocks or steps discussed in U.S. Pat. Pub. No. 2022/0335252 which is herein incorporated by reference in its entirety.

Where used throughout, a “product” may refer to any product intended for regular or irregular use on skin. For example, a product may include a cream, a lotion, a vitamin or mineral, an ointment, a serum, a moisturizer, a sunscreen, a pharmaceutical product, or the like. Where used throughout, a “treatment” may refer to regular or irregular application of a product, regular or irregular application of a non-invasive procedure (e.g., chemical peels, laser or light procedures, microdermabrasion, microneedling, etc.), regular or irregular application of an invasive procedure (e.g., Botox, dermal fillers, cryosurgery, surgery, etc.), or the like. In that regard, application of a “treatment” to skin may or may not include application of a “product” to the dermal region.

The server 102 may include any one or more server and may include processing capability. The server 102 may be in electrical communication with the user devices 106 via any known wired or wireless protocol or technique such as Wi-Fi, Bluetooth®, 5G, LTE, Ethernet, or any other communication protocol. The server 102 may run one or more algorithm that is designed to apply a dermal change function to one or more images. That is, the server 102 may receive an image that includes some skin, may determine a target modification to be applied to the dermal region, may retrieve a dermal change function that is associated with the target modification, and may modify the image by applying the dermal change function to the dermal region in the image. The server 102 may also perform additional logic functions as well such as training an AI algorithm based on a first set of pictures at a first time, a second set of pictures at a second time, and tags indicating the differences between the first set of pictures and the second set of pictures. The server 102 may also determine a dermal change function associated with a new product based on ingredients of the new product, may summarize the benefits achieved using a new product, and make product or treatment recommendations for a user based on parameters of the dermal region of the user and user goals related to her skin.

The memory 104 may include any one or more non-transitory memory in electrical communication with the server 102. In that regard, the memory 104 may store instructions usable by the server 102 for performing logic functions (e.g., may store instructions that correspond to an AI algorithm to be performed by the server 102). The memory 104 may also store additional information such as dermal change functions associated with certain products and treatments, tags associated with certain products or treatments, data as requested by the server 102 (e.g., pictures received by the server 102 from a user device 106), or the like. The memory 104 may be local to the server 102 (i.e., may be installed in a same machine as the server 102 (e.g., cache or random access memory (RAM) or a memory device directly coupled to the server 102), may be remote relative to the server 102 (e.g., may be a memory bank separate from the server 102 and in electrical communication with the server 102), may be a local or remote database in communication with the server 102, or the like. The server 102 and memory 104 may communicate using any technique such as wired or wireless communication protocols, positioning on the same bus, or the like.

The user devices 106 may include any type of user device such as smartphones, laptops, tablets, desktop computers, digital cameras, professional cameras, other relatively high-quality image capturing systems, or the like. For example, other relatively high-quality image capturing systems may include imaging devices that capture general images (e.g., professional cameras) or imaging devices designed for specific purposes. These specific-purpose imaging devices may include, for example, any medical imaging devices, skin-analysis imaging devices, imaging devices that capture or detect images in light spectrums other than the spectrum of light visible to humans (e.g., ultraviolet light spectrum), or any other imaging system or device designed to capture or detect image data in any light spectrum. The user devices 106 may be owned by individual users of the system 100, may be owned by brands that use the system 100 and place the user devices 106 in stores for use by users, or the like. The user devices 106 may communicate with the server 102 and may request certain information from the server. For example, a user device 106A may be a smartphone with which a user takes a picture of themself, transmits the picture to the server 102 along with skincare goals, receives product recommendations from the server, and outputs the product recommendations on an output device. As another example, a user device 106B may be a laptop computer that sends a picture of a user and a selected product to the server 102, receives a new image that shows long-term use of the selected product by the user, and outputs the new image on a display screen. As yet another example, a user device 106C may be a desktop computer at a dermatologist office that receives an image of a user along with identifiers of parameters of the dermal region of the user, transmits the image and parameters to a server, and outputs a new version of the image showing the dermal region 10 years down the road as a result of aging and the parameters.

The components of the system 100 may be in electrical communication via a network such as the Internet. For example, the server 102 may be located at a first location, the memory 104 may be a cloud memory hosted at a second location, and the user devices 106 may be located at user locations such as a storefront or carried by a user. Each of the server 102, memory 104, and user devices 106 may have a connection to the Internet such that each component may interact with other components of the system 100 via the Internet.

Referring to FIGS. 1A and 1B, an exemplary device 150 is shown. Any one or more of the server 102, the memory 104, or one or more user device 106 may include some or all of the features of the exemplary device 150. That is, the device 150 may function as any of the server 102, the memory 104, or the user device 106. The device 150 may include greater or fewer components than shown in FIG. 1B, may include duplicates of some components (e.g., the device 150 may be a dual processor device), or the like.

The device 150 may include a controller or processor 152. The processor 152 may include any controller or processor capable of performing logic functions. For example, the processor 152 may include an application-specific integrated circuit (ASIC), a general-purpose processor, a field programmable gate array (FPGA), any combination of discrete logic devices that perform logic functions, or the like. In some embodiments, the processor 152 may further include a local memory that stores instructions usable by the processor 152 to perform logic functions (e.g., cache memory, RAM, or the like). The processor 152 may be housed within the device 150, may include remote functionality (e.g., by providing cloud-based processing), or any combination thereof.

The device 150 may further include a memory 154. The memory 154 may include any non-transitory memory such as random-access memory (RAM), dynamic random-access memory (DRAM) read-only memory (ROM), or any other type of memory. The memory 154 may be housed within the device 150, may include remote memory (e.g., cloud-based memory or an external database), may be external relative to the device 150 (e.g., an external hard drive), or any combination thereof. The memory may store information usable by the processor 152 to perform logic functions, may store information as requested by the processor 152 for later retrieval, or the like.

The device 150 may further include an input device 156. The input device 156 may include any one or more input device such as a mouse, a keyboard, a touchscreen, a microphone, or the like. The input device 156 may receive input from a human user and convert the user input into digital signals usable by the processor 152. In some embodiments, the input device 156 may include a camera or other image-detecting component. For example, the input device 156 may include a camera on a smartphone that is designed to detect images such that a user can take a picture of themself or of another user using the camera. As another example, the input device 156 may include a webcam coupled to a desktop computer such that a user can take a picture of themself using the webcam. In some embodiments, the input device 156 may include a port (e.g., a Secure Digital (SD) card port, or a universal serial bus (USB) port) that can receive image data from a remote storage device.

The device 150 may further include an output device 158. The output device 158 may include any one or more output device such as a display, a touchscreen, a printer, a speaker, or the like. The output device 158 may receive a digital signal from the processor 152 and may convert the digital signal into a format that can be interpreted by a user (e.g., text or images on a screen, audio data, or the like).

The device 150 may also include a network access device 160. The network access device 160 may include one or more device capable of communicating with external elements via any wired or wireless protocol. For example, the network access device 160 may be or include a network card or adapter and port that facilitates communications via Ethernet, Bluetooth®, Wi-Fi, universal serial bus (USB), cellular protocols (e.g., 5G), or the like. In that regard, the network access device 160 may communicate with the processor 152, may transmit information from the processor 152 to a remote device as requested by the processor 152, and may transmit information from a remote device to the processor 152. The network access device 160 may communicate with remote devices (e.g., may communicate with a remote server via the internet), may communicate with local devices (e.g., may communicate with a local printer), or the like. In that regard, the server 102, the memory 104, and the user devices 106 may communicate with each other via respective network access devices 160 and external communication means (e.g., ethernet cables, Wi-Fi routers, 5G routers, the Internet, or the like).

The device 150 may further include a power supply 162. The power supply is designed to provide power to the device 150, providing electricity to the components of the device 150 to allow them to operate. The power supply 162 may include any power supply and related components such as a cable and transformer designed to receive power from a wall socket, a converter or inverter, a battery, a supercapacitor, or any alternative or additional power supply.

The device 150 may also include connections or a bus 164. The connections or bus 164 may be connected to some or all components of the device 150 and may transmit at least one of a power signal or a data signal between components of the device. For example, power from the power supply 162 may be transmitted to the various components via the connections or bus 164, the processor 152 may control the output device 158 by placing instructions on the connections or bus 164, the processor 152 may receive information from the network access device 160 via the bus 164, or the like. In some embodiments, the power provided by the power supply 162 may be distributed via the bus 164, may be distributed via a separate bus or connection, or the like.

Referring now to FIGS. 2A and 2B, a method 200 for simulating modifications to dermal regions is shown. Although the term “modification” is used, a “modification” may include a modification to any dermal region such as skin, hair, pores, teeth, nails, lips, or the like. A dermal region may include any one or more of skin, hair, pores, teeth, nails, lips, or the like, which may be included as part of one or more body part such as hands, palms, legs, armpits, arms, feet, back, neck, decollete, or the like. The method 200 may be performed by components of the system 100 of FIG. 1A, which may in turn contain components of the device 150 of FIG. 1B. The method 200 may be used in multiple situations such as: a user wishing to see how her skin appears in the future under various conditions; a beauty supply brand wishing to see long-term results of a new product in trials; a store wishing to show potential customers how various products will affect their skin after some time; or the like. The various processing steps may be performed by a server, by a user device, or by some combination thereof; for example, a user device may perform some processing and may transmit the results of the initial processing to a server for final processing.

In block 202, an image containing skin may be received. The image may be received in any manner without departing from the scope of the present disclosure. For example, a camera coupled to a user device may capture an image of a user that shows a portion of the user’s skin (e.g., a camera on a mobile device such as a smartphone, a tablet, a laptop, or the like). As another example, a user device may access an image stored on a social media account associated with a user, or may retrieve an image from a local memory or the cloud. As yet another example, a user device may receive an image from another device (e.g., a user may capture an image using their cell phone and may transmit the image to a desktop computer which may operate as a user device). As yet another example, a user may insert a SD card into a port on a laptop computer, and one or more image (which may be from a professional photographer or a macro imaging device) may be retrieved from the SD card.

In block 204, a processor may identify a target modification. The processor may include any processor such as that of a server, that of a user device, or the like. The modification may be or include any modification such as application of a cosmetic product, a medical treatment, exposure to a specific environment, or the like. For example, the modification may include aging for a first period of time without application of any treatments or products. As another example, the modification may include regular application of a product over a second period of time. As another example, the modification may include long-term results of a one-time procedure. In that regard, the target modification may be modified to correspond to any duration, any regular or irregular treatment or product application, or the like. The target modification may include a modification (e.g., application of a specific product, exposure to a specific laser treatment), a frequency of the modification (e.g., once per week or every 25 days), a duration of the modification (e.g., for 20 years, for 5 years, or once), a magnitude of the cause of the modification (e.g., a specific amount of cosmetic product applied at each interval, or a quantity of cigarettes smoked per day), and any other applicable information. This additional information may be received from the user, may be estimated based on certain identified information, may be determined based on average use, or the like.

The target modification may be identified in any known way. For example, a user may specify the target modification by, for example, providing input indicating the parameters of the target modification (e.g., “show me my skin in 10 years with daily application of Product X”). This input may be received via any input device and using any user interface. For example, the input may be received by a user device and transmitted to a processor of a server. As another example, an owner of a user device may specify particular parameters of the target modification (e.g., “show all customers the results of monthly microneedling over 10 years”). As another example, a store owner may provide options for a user to select any of a predetermined list of modifications and a predetermined amount of time, such that the user may select the modification and the duration. As yet another example, researchers may provide a list of ingredients in a new product and request to see the results after a period of use at a regular frequency (e.g., “apply this new product with ingredients a, b, and c to the dermal region in each of the provided 100 images every other day for 20 years”).

In some embodiments, the processor may identify an agent of influence before, or as part of, identifying the target modification. The agent of influence may be identified in any way, similar to the way the target modification is identified. The agent of influence, for example, may include at least one of a cosmetic product, a medical or cosmetic treatment, or an influence (which may include any other product or action that may affect the dermal region over time, such as smoking or moving to a low humidity desert). The agent of influence may include, for example, application of a cosmetic product, an intervention, procedure (e.g., a cosmetic procedure such as facial rejuvenation, body contouring, fillers, Botox injections, chemical peels, laser hair removal, or skin resurfacing; or a wellness procedure such as massage, acupuncture, or stress-reduction techniques), lifestyle change (e.g., changing a diet, adjusting or adding an exercise routine, starting a meditation program, etc.), wellness change, exposure to ultraviolet (UV) light, physiological excitement, an illness, or the like. In that regard, the target modification may incorporate the agent of influence. For example, a target modification may include aging 10 years while being a cigarette smoker. The agent of influence may include cigarettes and the target modification includes a 10-year effect of smoking. In some embodiments, the target modification may include the agent of influence without explicitly stating so (e.g., claim language stating “identifying a target modification” may include the action of an agent of influence even if the claim fails to mention anything regarding an agent of influence). In that regard, the agent of influence may include any product or procedure that affects the dermal region (or dermal region).

In some embodiments, it may be desirable for a target modification to be shown on a different body part than a source anatomical region. For example, the source anatomical region may include a region shown in the received image (e.g., the received image may include a face, and so the processor may identify the source anatomical region as the face). In some embodiments, a detection algorithm may identify one or more region shown in the received image (e.g., the image may include part of a torso and a full arm; the detection algorithm may determine that the full arm is the source anatomical region). As another example, the source anatomical region may be identified by a user (e.g., the received image may be a full-body image, and the user may use an input device to indicate that the source anatomical region is the face, the arms, or the like).

In some embodiments, the user (or system) may select a target anatomical region to which the target modification will be applied. For example, a user may use an input device to inform the processor of the target anatomical region. In some embodiments, the system may be designed to automatically select a target anatomical region; for example, a makeup store may always select the face to be the target anatomical region.

In some embodiments, the target modification may be described using natural language. For example, a user may use an input device (such as a keyboard, a mouse, a microphone, or the like) to provide the target modification as a natural language textual prompt. For example, the user may type the natural language textual prompt “show me the results of a two-hour facial massage on my skin” or “show me the results of lip fillers.” The processor may convert the natural language into multimodal embedding. For example, the processor may make this conversion using a text encoder algorithm. In some embodiments, the processor may make this conversion using an AI algorithm. The processor may derive the dermal change function from the natural language using both the natural language textual prompt and the multimodal embedding. In this regard, the image output in block 212 will have the target modification described by the natural language textual prompt applied thereto.

In block 206, the processor or another processor may retrieve a dermal change function that is associated with the target modification. The dermal change function may be an algorithm or other digital processing technique that defines a change in skin over time for the selected target modification. That is, the dermal change function may determine changes in skin based on various inputs, such as parameters of a user’s skin, inputs received from a user (e.g., age, race, tanning level, or the like), etc. A database or memory may store separate dermal change functions for each target modification (e.g., a first function for application of a moisturizer, a second function for application of microneedling, etc.). In some embodiments, the database or memory may store multiple dermal change functions for each target modification (e.g., a first function for the first 5 years of application of a moisturizer and a second function for the next 10 years; a first function for application of microneedling by fair skinned individuals and a second function for application of microneedling by darker skinned individuals).

The dermal change functions may be determined in any way. For example, a written description of the dermal change functions may be provided, a computer may be programmed to incorporate certain effects for each dermal change function, an artificial intelligence (AI) algorithm may be trained with data to create each dermal change function, or the like. The dermal change functions may be determined based on at least one of scientific literature, published reports, academic presentations, medical studies, images from any of these sources, or the like. For example, these sources may be used by an AI algorithm to learn the dermal change function.

In some embodiments, the target modification may correspond to aging of the user without use of any additional products or processes. A corresponding dermal change function may then simulate normal aging of skin of the user based on the various parameters of the user’s skin (e.g., current age, coloring, skin tone, damage, etc.). In this way, the method 200 may simulate standard skin aging as well as aging with the application of a product or process, allowing a user to view results of aging both with and without application of products or processes.

In some embodiments, the processor may create a dermal change function based on specific inputs. For example, a general dermal change function may apply to all skin types, and the processor may modify the dermal change function based on the skin tone of the individual and the product the individual wants to simulate. As another example, dermal change functions may exist for each ingredient of a product, such that the processor combines multiple dermal change functions based on ingredients in a specific product identified in the target modification.

In some embodiments, a memory that is local to the processor may store the dermal change function. For example, a computer at a store may be told to always simulate application of a first product, and a memory local to the computer may store the dermal change function associated with the first product in a local RAM.

In block 208, the processor may analyze the image to locate regions in the image that contain skin. For example, the processor may use an artificial intelligence algorithm or other algorithm to identify portions in the image that are skin and other portions that contain non-skin information. In some embodiments, the processor may prepare a skin-only image by removing all pixels containing non-skin information from an image (or copy of an image). The processor may store the removed non-skin information so that it is able to replace the non-skin information at some point.

In some embodiments, the processor may also identify parameters associated with the dermal region in block 208. For example, the processor may identify the coloring or skin tone of the dermal region based on the dermal region detected in the image, or may identify other information such as complexion or skin type of the user. In some embodiments, the processor may request user input indicating the ethnicity of the user or other user-specific information (e.g., whether the user tans relatively easily, the natural hair color of the user, the natural eye color of the user, or the like). The processor may also identify any existing damage (e.g., sun damage) already applied to the dermal region along with any additional abnormalities, defects, or other characteristics (e.g., wrinkles, sunspots, or the like). In some embodiments, the processor may also analyze the dermal regions of the image to determine if there is any makeup or other beauty products already applied to the dermal region. If so, the processor may request a new image that includes the dermal region without makeup, or the processor may attempt to digitally remove the effects of the makeup or other beauty products. In some embodiments, the processor may also or instead utilize an internal quality assurance system that orchestrates the image capturing process while capturing images to ensure that the resulting images align with proper guidelines (e.g., proper room lighting, no wearing of glasses, optimal distance between the camera and the body part, no use of makeup, etc.).

The processor may also analyze the dermal region to estimate an age of the dermal region based on the identified parameters. In some embodiments, the processor may utilize an artificial intelligence (AI) algorithm to estimate the age of the dermal region (or generally the age of the user). In some embodiments, the processor may request user input indicating the age of the user. This may be useful as some dermal change functions may be non-linear (e.g., may have more of an effect from age 25 to 35 than before age 25 or after age 35), so the processor may correctly apply the dermal change function based on the estimated or received age of the user.

In block 210, the processor may apply the dermal change function to the regions identified as skin in the image. The dermal change function may be applied based on the specific function and based on a quantity of inputs (e.g., inputs received from the user or identified based on the image data). For example, the function may be applied for the identified period of time and at the identified frequency. The function may also be applied based on a current amount of skin damage, based on a current age of the user, based on a skin tone or other coloring, based on a current amount of sun damage, or the like. Each of these inputs may affect the results of the dermal change function on the dermal region, so it may be desirable to obtain as much accurate information as possible from the user and/or from the dermal region data in the image as possible before applying the dermal change function. In that regard, if certain information cannot be determined and is considered as an input to the retrieved dermal change function, the processor may cause the user device to output a request for any missing information.

In some embodiments, each dermal change function may have a predetermined list of inputs required for optimal results. Before applying the dermal change function, the processor may ensure that it has at least some information corresponding to each of the inputs. In some embodiments, the processor may score each piece of information for the inputs based on a confidence level regarding accuracy (e.g., level 1 is not confident at all and level 10 is totally confident). The processor may be programmed to only proceed if a confidence level of each input is greater than a predetermined level, and may request user feedback for any input information that is less than the predetermined level. In some embodiments, the processor may request user feedback for any information that it is not confident of above a predetermined level. In that regard, the processor may provide output with a relatively great accuracy level.

In some embodiments, a digital signal processor (DSP) or graphics processing unit (GPU) may be used to identify the parameters of the dermal region in the image and to apply the dermal change function to the dermal region in the image. These processors may provide greater accuracy and quality of output than other processors and thus may be preferable. For example, the processing performed by the GPU or DSP may be performed by the server and other processing may be performed by a processor of a user device. In some embodiments, non-DSP or non-GPU processors may be used.

In some embodiments, an artificial intelligence (AI) algorithm (e.g., a generative AI algorithm) may be used to apply the dermal change function to the dermal region in the image. In that regard, the AI algorithm may be trained to adjust an appearance of the dermal region based on the specific function and inputs received from the user. In some embodiments, the AI algorithm may be conditioned with parameters derived from the dermal change function. The AI algorithm may be used to synthesize the image of the dermal region based on the conditioning and the function, or may synthesize features (e.g., textures, coloring, skin tone, etc.) of the dermal region based on the conditioning and the function.

In embodiments in which a source anatomical region and a target anatomical region are identified, the processor may apply the dermal change function to the target anatomical region. For example, the processor may determine characteristics of the dermal region in the image, may apply the dermal change function to the dermal region in the image, and then may utilize the characteristics of the dermal region and the dermal change function to create a new image of the target anatomical region to which the dermal change function is applied. In some embodiments, a procedure may have already been applied to the source anatomical region. In these embodiments, the processor may determine the dermal change function that was applied to the source anatomical region based on the received image and characteristics of the dermal regions in the image, and may apply the dermal change function to the target anatomical region to show the results if the procedure were applied to the target anatomical region.

In some embodiments, the received image may be captured using light that is within a first frequency range, and new image may be shown using light that is within a second frequency range that is at least partially different from the first frequency range. For example, these frequency ranges may include light within the spectrum that is visible to humans (between 380 and 750 nanometer wavelength light), a portion of the visible light spectrum (e.g., between 400 and 500 nanometer wavelength light), ultraviolet (UV) light, infrared (IR) light, near infrared (NIR) light, or any other frequency range. In that regard, the processor may transfer a representation of the dermal region from the received image in the first frequency range to a representation of the dermal region in the second frequency range. For example, light captured in the UV spectrum may be converted to an image in the visible light spectrum to allow the user to see the data. In some embodiments, the processor may be pre-programmed to select the first and/or second frequency range. In some embodiments, the user may select the first and/or second frequency range based on characteristics that the user is interested in. Changing frequency ranges in this manner may show information that is not easily illustrated in the visible light spectrum. For example, the information from the second frequency range that is output may illustrate at least one of subsurface features beneath the surface of the dermal region; features on the surface of the dermal region that are not easily shown in the visible light spectrum; or enhanced features that are more easily shown in the visible light spectrum.

In block 212, the processor may instruct an output device to output the new image. The new image may include the non-skin information from the original image along with the new skin information that results from the application of the dermal change function to the original skin information. In some embodiments, the processor may also be designed to apply a change function to non-skin information. For example, the processor may thin out hair identified in the image, may reduce a weight of the subject of the image, or the like. In some embodiments, a user may provide input indicating any additional changes (or non-changes) requested along with the new skin. In some embodiments, the dermal change function may also take into account changes in skin that result from aging. For example, the dermal change function may apply a certain identified product for an identified period of time, and may also incorporate standard aging of users with similar skin parameters over the identified period of time.

In some embodiments, the processor may generate multiple new images based on the dermal change function applied to the dermal region in the image. For example, the processor may use a generative AI algorithm to generate images of the dermal region from different angles, three-dimensional views of the subject with the dermal region, or videos that show the target modifications applied to the dermal regions.

The output device that outputs the new image may be associated with a user device, with the server, or any combination thereof. For example, a GPU in a server may apply the dermal change function and create the new image, and may transmit the new image to a user device (e.g., a smartphone or a computer in a store) to output the new image. In some embodiments, the server may be located at a user location (e.g., a store) and may perform the processing and output the new image on a local output device (e.g., a display). In some embodiments, some or all of the processing may occur on a processor on a user device such that a server may be unnecessary – in these embodiments, the user device may also include an output device on which to output the new image.

In some embodiments, it may be desirable for a processor to generate descriptive language that describes the dermal change function; in that regard, in block 214, the processor may generate this descriptive language. For example, if the dermal change function is associated with a new product and is determined based on dermal change functions associated with various ingredients of the new product, it may be desirable to have both before and after images of the function of the new product and also a description of the effects of the new product. In that regard, the processor may generate descriptive language based on at least one of the parameters of the dermal change function, at least a portion of the before and after images (i.e., the input images and the new images it generates), or some combination thereof. This descriptive language may be used as marketing copy or other marketing- or sales-related language. For example, the descriptive language may describe at least one of the dermal change function, results of application of a cosmetic product, results of a medical treatment, results of the exposure to the environment, or the like. In some embodiments, the descriptive language may describe the effects of the product, treatment, exposure to the environment or the like. The processor may use any type of algorithm to generate this descriptive language, such as an artificial intelligence (AI), machine learning (ML), or other algorithm. Large language models (LLMs) may be particularly well suited for this descriptive language generation.

It may also be desirable to generate a product description that describes a cosmetic product or a medical treatment associated with the dermal change function; in block 216, the processor may generate this product description. This description may be similar to the descriptive language that describes the dermal change function, but may include more information regarding the product or procedure than the descriptive language of block 214. Whereas the descriptive language of block 214 may be more focused on the changes caused by the dermal change function, the descriptive language of block 216 may be more focused on information regarding the product or treatment (e.g., ingredients and effects of the various ingredients, specific steps involved in a procedure, frequency of application of a product, frequency of application of a procedure, or the like).

As described above, the processor may be capable of identifying parameters of the dermal region in the image. This identification of parameters may be useful not only for applying a dermal change function to skin, but also to generate recommendations for the specific skin parameters for a given user. For example, certain products or treatments may be best suited for a certain set of skin parameters and other products or treatments may be best suited for other sets of skin parameters. The method 200 may also be suitable for generating recommendations of products or procedures for a user based on skin detected in a user image.

In that regard and in block 218, the processor may again analyze the dermal region in the input image to identify various parameters of the dermal region. As indicated above, the dermal region parameters may include any parameters relating to the dermal region of the user. For example, the parameters may include the age of the subject, any existing damage to the dermal region (e.g., sun damage, trauma, wrinkles, sagging, volume loss, scars, hyperpigmentation, changes in pigmentation, vascular conditions (such as rosacea or spider veins), redness, or the like), any disorders (e.g., acne, eczema, psoriasis, moles, warts, breakouts, dry skin patches, etc.), and any additional or alternative abnormalities. The parameters may also include a skin tone or other coloring of the dermal region, an ethnicity of the user, a current tanning level of the user, or the like. The parameters may further include whether any makeup or other cosmetic is being worn by the user. The processor may identify any of these parameters based on the received image data, may request confirmation of any identified parameters, may request parameter information from the user for any non-confidently identified parameters, or any combination thereof.

In block 220, the processor may identify a cosmetic product or procedure that is suited to treat, reduce, or modify one or more of the parameters identified in block 218. In some embodiments, the user may also provide user input indicating goals related to her skin (e.g., reduce acne or other breakouts, slow down aging of the dermal region, eliminate wrinkles, etc.). In these embodiments, the processor may analyze the parameters of the dermal region, analyze the goals of the user, and identify one or more product or procedure that is usable to achieve the goals of the user based on the user’s current skin parameters. For example, the processor may identify the most likely product or procedure to achieve the user goals, may identify the top 2, 3, 5, 10, etc. products or procedures to achieve the user goals, may identify the top 1, 2, 3, etc. products and the top 1, 2, 3, etc. procedures to achieve the goals, may identify any products or procedures that have a greater likelihood of success than a predetermined threshold (e.g., 50 percent, 80 percent, 95 percent, etc.), or the like.

In some embodiments, the processor may identify products or procedures for the user without receiving user input regarding specific desires. For example, the processor may be aware of certain parameters or ranges of values for parameters that are desirable and other parameters or ranges of values for parameters that are undesirable. The processor may determine the top 1, 2, 3, etc. parameters of the user’s skin that have values that are undesirable values for the specific parameter and may determine that improvement in those parameters is desirable. As another example, the processor may be aware of ranges of values for parameters that are present in an average human and may identify any parameters that have values outside of the respective range as parameters to improve.

In order to identify the product(s) or procedure(s) to recommend to the user, the processor may utilize an algorithm (e.g., an AI or ML algorithm) that generates product recommendations based on various inputs. The inputs that the algorithm utilizes may include any user-indicated goals, any parameters to be improved upon (based on the processor’s analysis), the specific skin parameters of the user, a list of potential products and procedures and their respective dermal change functions (or other information related to the dermal change functions), and the like. The potential products and procedures which the algorithm analyzes may include all known cosmetic products and all known procedures, or may be limited to certain products and/or procedures based on a setting of the system implementing or hosting the method 200 (e.g., a cosmetics brand may only utilize its products when making recommendations to a user, or a wellness facility may only utilize certain products or procedures for various types of massage or beauty procedures).

In some embodiments, one or more tags may be associated with each product or procedure. For example, the tags may correspond to parameters with which it works, benefits which it may provide, or the like. The processor may identify one or more desirable tags based on the various inputs and may limit the list of potential products or procedures based on the desirable tag(s) and the tag(s) associated with the products or procedures.

In block 222, the processor may control an output device to output an identifier of the product(s) or procedure(s) that is/are recommended to the user. In some embodiments, the processor may rank the product(s) or procedure(s) based on the likelihood of success of each product and/or procedure. In some embodiments, the processor may also generate a likelihood of success of each recommended product or procedure. In some embodiments, the processor may generate one or more new image for each recommended product or procedure that shows the results of use of each product or procedure at one or more future time (e.g., 5 years from that moment, 10 years from that moment, 20 years from that moment, or the like) and for one or more frequency of use (e.g., daily application, once per week application, a one-time procedure, etc.). In some embodiments, the processor may also output at least one of a likelihood of success or one or more new image for each recommended product or procedure and for one or more product or procedure offered by a competitor to show how the present recommendations can achieve better results.

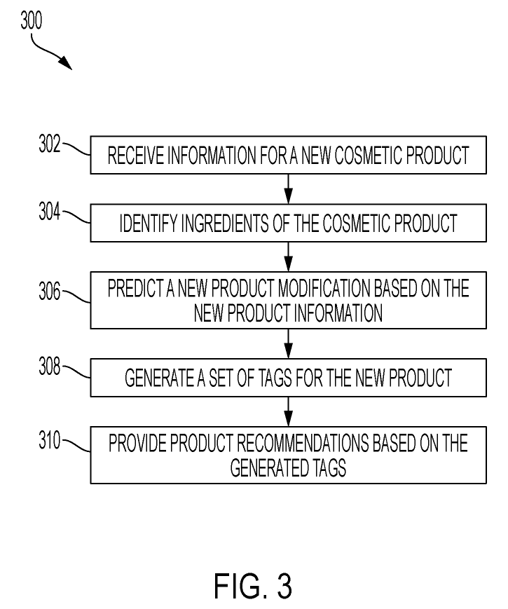

Turning now to FIG. 3, a method 300 for analyzing potential products or new products, and for generating a dermal change function of the potential products or new products, is shown. The method 300 may be used, for example, by a research team attempting to generate new cosmetic products, by a medical team attempting to develop a new cosmetic procedure, by a brand attempting to add a new potential product to its list of recommendations, or the like. The method 300 may be performed, for example, by components of a system such as the system 100 of FIG. 1A.

In block 302, a processor may receive information corresponding to a new cosmetic product or procedure. The information may include, for example, a name of the product, ingredients of the product, steps of the procedure, target application frequencies of the product or procedure, potential benefits of the product or procedure, target benefits provided by the product or procedure, or the like. In some embodiments, the information may include before and after pictures from before and after application of the product or procedure along with duration and frequency of application.

In block 304, the processor may identify ingredients of the new cosmetic product or steps of the procedure. The processor may have access to dermal change functions or other information associated with each ingredient or each step of a procedure, or may determine dermal change functions based on before and after images. For example, the processor may receive input indicating that new product X has ingredient A, B, and C, and may include the concentrations or quantities thereof in the new product X. The processor may lookup or retrieve dermal change functions for each of ingredient A, ingredient B, and ingredient C, or the processor may receive or retrieve before and after pictures (or expert descriptions) of application of ingredient A, ingredient B, and ingredient C and determine dermal change functions for each based on the before and after pictures. In some embodiments, the processor may have access to research information for each of ingredient A, ingredient B, and ingredient C and may determine the dermal change functions for each based on the research information.

In block 306, the processor may predict a new product modification that indicates an effect on skin of the new product or process based on the new product information including ingredients and/or steps. The new product modification may include, for example, a dermal change function to be applied to images that include skin, may include a description of the dermal change function, may include a product or procedure description of the new product or procedure, or the like. For example, the processor may create a new dermal change function based on the functions associated with each ingredient (or each step) by combining the dermal change functions. As another example, the processor may generate a dermal change function by analyzing before and after pictures and their associated information regarding duration and frequency of application. As another example, the processor may compile all of the research information regarding the independent ingredients (or steps) along with any research regarding combinations of any of the ingredients (or steps) and generate a new dermal change function based on the research. In some embodiments, the processor may compile all accessible information regarding the ingredients, research, and any before an after picture to create a comprehensive dermal change function. In some embodiments, the processor may convert between identified dermal change functions, descriptive language that describes the dermal change function, descriptive language that describes the new product or procedure, or the like based on the desired format of the new product modification.

In block 308, the processor may generate a new set of tags for the new product or procedure. For example, the tags may correspond to skin parameters affected by the new product or procedure, benefits achieved by the new product or procedure, needs addressed by the new product or procedure, product activity and mechanism of effect of the new product or procedure, class solution of the new product or procedure, a category of the new product or procedure, an optimal frequency of application of the new product or procedure, skin types or skin colors for which the new product or procedure is most applicable, age of users for which the new product or procedure is most applicable, skin problems or diseases for which the new product or procedure is helpful, or any other information regarding the new product modification. These tags may be used, for example, when a user is requesting recommendations for products or procedures such as, for example, in block 220 of the method 200 of FIGS. 2A and 2B.

In that regard and in block 310, the processor may generate product or procedure recommendations based on the generated tags regarding the new product. These recommendations may be performed in a similar manner as the recommendations provided in block 220 of the method 200 of FIGS. 2A and 2B and in a similar method or may be provided in a separate method. For example, a user may provide input indicating what the user is looking for along with any parameters associated with the user (or a processor can identify parameters based on an input image), the processor may identify desirable tags associated with the user’s request, and may identify products or procedures by comparing the desirable tags with tags for the new product or procedure.

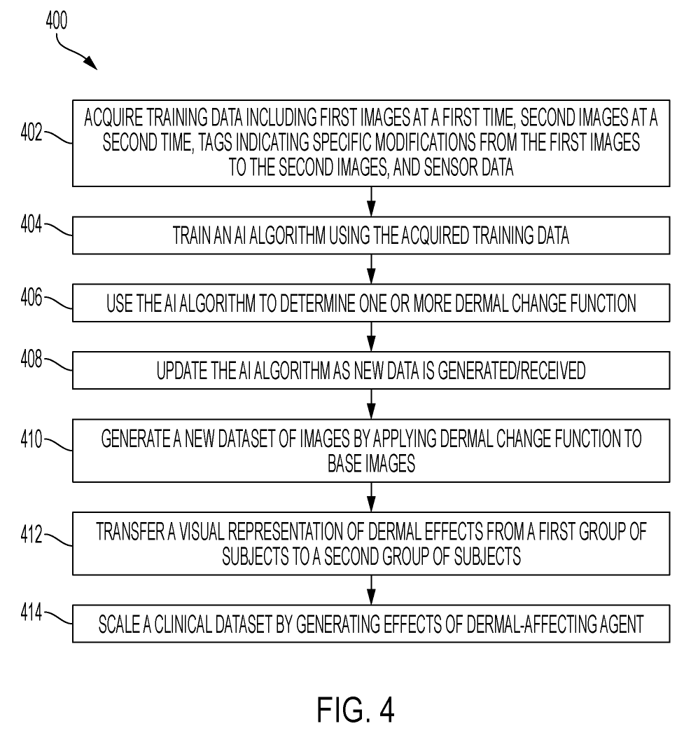

Turning now to FIG. 4, a system such as the system 100 of FIG. 1A may be used to train a recommendation algorithm or an algorithm that applies dermal change functions to images based on hypothetical application of products or procedures. In that regard, a method 400 may be used to train a recommendation or dermal change function algorithm for cosmetic products or procedures, and may also be used to scale clinical datasets for medical trials for new products and procedures.

In block 402, a processor may acquire training data for training an AI algorithm. The training data may be provided by a user or accessed via a database and may include images, test results, sensor data, and any other relevant information. For example, the training data may include a first set of images taken at a first time (e.g., before application of any product or procedure), a second set of images taken at a second time (e.g., after application of a product or procedure, and may all be taken at a set time duration since the first set of images or all at different durations), tags indicating specific modifications between the first and second images (e.g., application of X product over Y time period and with a frequency of application of Z), data from product studies (e.g., scientific publications describing certain treatments and providing measured results from the treatments), sensor data (e.g., specific sensor data collected during studies of a product or process, such as measured data from before application and weekly measured data during application of the product or procedure), and any additional information that relates to the product or procedure such as ingredients, specific steps, or any additional relevant information.

In block 404, the processor may train an AI or ML algorithm using the acquired training data. The AI or ML algorithms may include any known algorithms such as supervised learning models that learn from labeled data to make predictions on new data, unsupervised learning models that explore an inherent structure of the data without predefined categories or labels, semi-supervised learning models that leverage both labeled and unlabeled data to improve model performance, reinforcement learning models that learn through trial and error, or any other known models. In some embodiments, the AI or ML algorithm may also or instead generate descriptive language and may thus include natural language processing models. The algorithm may be trained using any known technique based on the specific AI or ML model(s) used in the methods.

In block 406, the AI or ML algorithm may be used by the processor to determine one or more dermal change function. For example, the AI or ML algorithm may generate dermal change functions for various target modification based on the training data. That is, the AI algorithm may create a dermal change function for each target modification on which it is trained. The processor may receive training data in block 402 associated with one or more target modification (e.g., application of a first product, periodic application of a skincare process, application of a number of ingredients), may train the AI algorithm in block 404 to learn the effects of the various modification(s), and may create dermal change functions for each of the modification(s) based on the training data and trained AI algorithm. In some embodiments, the AI algorithm may be trained based on a measured effect of certain agents of influence, which measured effects may be measured in a controlled or semi-controlled environment (such as a research laboratory). In some embodiments, the measured effect may be determined based on at least one of sensor data or expert annotation data that indicates changes in measurements over time that correspond to changes in skin features. In this way, the accuracy of the measured effects may be relatively great.

The dermal change function learned in block 406 may function as the dermal change function that is retrieved in block 206 of FIG. 2A, and may thus be capable of altering skin in an input image using the dermal change function. For example, the processor may receive an input image having skin, an identifier of a product or process to be applied to the dermal region, and a duration and frequency of application of the product or process. The processor may then retrieve the dermal change function based on the identifier of the product or process, provide the input image and the duration and frequency of application as an input, and generate an updated image that shows the target modification using the dermal change function and the inputs.

In this manner, the method 400 may be used to train the AI algorithm to operate in the method 200 of FIGS. 2A and 2B and the method 300 of FIG. 3. As the methods 200 and 300 are functioning, the processor may receive more data such as new input images, new cosmetic product information, new ingredient information, new tags, etc., and may also receive new training data along with user feedback on the methods 200 and 300. As the AI algorithm operates and receives new inputs and feedback and iteratively performs the various blocks, the processor may update the AI algorithm in block 408 based on the newly received information. In this way, the processor may continuously update the AI algorithm as new information is received and processed, allowing the algorithm to continuously update and improve.

As a result of the powerful nature of the algorithm, the method 400 may also be used to supplement research findings and study data. In block 410, the processor may generate a new dataset of images to supplement research findings and study data. The processor may do so by receiving a number of new images (“base images”) and applying the dermal change function for the specific modification being studied. In this manner, the processor may apply the dermal change function to each of the base images, resulting in new images that simulate application of the product or process on the base images. The new images that show the application of the product or process may be used in studies which research the new product or process. For example, training data regarding application of a new product or process may be provided, the algorithm may learn a dermal change function based on the training data, and may generate new images based on the learned dermal change function. Thus, the method 400 may be used to supplement study data to increase a quantity of data.

The generation of the new dataset of images may be created for any period of time past the collection of the base images. For example, the method 400 may generate a first set of images that show intermediate changes between a first point in time (i.e., the time of the base images) and a second point in time. The method 400 may also or instead generate a second set of images that show the effect beyond the second point in time. This second set of images may illustrate continued evolution of specific modifications.

In block 412, the processor may transfer a visual representation of skin effects from a first group of subjects to a second group of subjects. In some embodiments, this block may incorporate features of blocks 402 through 410 and may be performed in a similar manner or in a different manner. The processor may be fed training data that includes a first set of images corresponding to pre-treatment skin, a second set of images corresponding to post-treatment skin, and tags indicating the type, duration, and frequency of treatment. The processor may learn the dermal change function associated with the type, duration, and frequency of treatment based on the training data. The processor may then receive a new set of images of pre-treatment skin and apply the dermal change function to the new set of images to transfer the effect of the treatment from the training images to the new set of images.

In block 414 and as discussed above, the processor may user the above blocks to scale a clinical dataset. The processor may do so by generating effects of a skin-affecting agent such as application of a new product or application of a new process. The effects may be generated by applying learned dermal change functions to new images, by generating descriptive language describing the effects of the new product or process, or the like. Use of the method 400 to scale clinical datasets may save valuable time and money in studies of new products and processes, thus reducing the cost and duration of new product and process research.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A method for simulating modifications to a dermal region in an image, the method comprising:
receiving the image that includes the dermal region;
identifying a target modification to apply to the dermal region in the image;
retrieving a dermal change function associated with the target modification;
locating at least one area of the image containing the dermal region;
adjusting the image by applying the dermal change function to the at least one area of the image containing the dermal region to achieve the target modification; and
outputting the adjusted image with the target modifications applied to the dermal region.

2. The method of claim 1, wherein the dermal region includes at least one of skin, hair, nails, eyelashes, or teeth.

3. The method of claim 1, wherein the image is received from at least one of a mobile device, a professional imaging device, or a macro imaging device.

4. The method of claim 1, wherein:
the target modification includes a cause of modification and a duration of the cause of the modification; and
adjusting the image includes applying the dermal change function for the cause of the modification by an amount that corresponds to the duration of the cause of the modification.

5. The method of claim 2, wherein:
the target modification includes a magnitude of a cause of the target modification; and
adjusting the image includes applying the dermal change function for the cause of the modification by another amount that corresponds to the magnitude of the cause of the modification.

6. The method of claim 1, wherein adjusting the image includes:
conditioning a generative artificial intelligence (AI) algorithm with parameters derived from the dermal change function; and
using the generative AI algorithm to synthesize at least one of the adjusted image or specific texture details shown in the adjusted image.

7. The method of claim 1, further comprising:
identifying a source anatomical region in the received image corresponding to at least one of a body part shown in the received image or a body part identified by a user;
receiving a selection of a target anatomical region that is different from the source anatomical region;
mapping the dermal change function from the source anatomical region to the target anatomical region using a cross-domain synthesis algorithm; and
generating a new image such that the target modification is rendered on the target anatomical region based on data extracted from the source anatomical region.

8. The method of claim 1, wherein identifying the target modification includes:
receiving a natural language textual prompt describing the target modification to be applied to the dermal region;
converting the natural language textual prompt into a multimodal embedding using a text encoder algorithm; and
deriving the dermal change function at least in part based on the natural language textual prompt and using the multimodal embedding when adjusting the image by applying the dermal change function.

9. The method of claim 1, wherein the received image is associated with light within a first frequency range, and wherein adjusting the image includes:
transferring a representation of the dermal region from the first frequency range to a second frequency range, wherein the first frequency range and the second frequency range are different; and
adjusting the image further includes outputting information from the second frequency range to illustrate at least one of subsurface, non-visible, or structurally enhanced dermal features corresponding to the target modification.

10. A method for simulating modifications to a dermal region in an image, the method comprising:
receiving an image that includes the dermal region;
identifying a target modification to apply to the dermal region in the image, the target modification being associated with at least one of application of a cosmetic product, a wellness procedure, a cosmetic procedure, a medical treatment, or exposure to an environment;
retrieving a dermal change function associated with the target modification;
locating at least one area of the image containing the dermal region;
adjusting the image by applying the dermal change function to the at least one area of the image containing the dermal region to achieve the target modification; and
outputting the adjusted image with the target modifications applied to the dermal region.

11. The method of claim 10, further comprising:
generating descriptive language that describes the dermal change function, the descriptive language describing results of the at least one of the application of the cosmetic product, the medical treatment, or the exposure to the environment; and
outputting the descriptive language that describes the dermal change function.

12. The method of claim 11, further comprising generating a written description of the effects of the cosmetic product, the medical treatment, or the exposure to the environment based on the descriptive language that describes the dermal change function.

13. The method of claim 10, wherein the dermal change function is determined based on at least one of scientific literature, published reports, academic presentations, or medical studies.

14. A method for simulating modifications to a dermal region in an image, the method comprising:
receiving an image that includes the dermal region;
analyzing the image to identify one or more parameters of the dermal region;
identifying an agent of influence usable to at least one of affect, or reduce the likelihood of progression of, at least one of the one or more identified parameters;
identifying a target modification to apply to the dermal region in the image, the target modification being associated with application of the agent of influence;
retrieving a dermal change function associated with the target modification;
locating at least one area of the image containing the dermal region;
adjusting the image by applying the dermal change function to the at least one area of the image containing the dermal region to achieve the target modification, such that the adjusted image illustrates results of the application of the agent of influence; and
outputting the adjusted image with the target modifications applied to the dermal region, and outputting an identifier of the agent of influence.

15. A method for simulating modifications to a dermal region in an image, the method comprising:
receiving an image that includes the dermal region;
identifying a target modification to apply to the dermal region in the image;
determining a dermal change function associated with the target modification using an artificial intelligence (AI) algorithm and based on a measured effect in a controlled or semi-controlled environment;
locating at least one area of the image containing the dermal region;
adjusting the image by applying the dermal change function to the at least one area of the image containing the dermal region to achieve the target modification; and
outputting the adjusted image with the target modifications applied to the dermal region.

16. The method of claim 15, wherein the measured effect is determined based on:
a first set of images of at least one subject taken at a first point in time;
a second set of images of the at least one subject taken at a second point in time that is different than the first point in time; and
tags indicating specific modifications applied to the at least one subject between the first point in time and the second point in time.

17. The method of claim 16, wherein the specific modifications correspond to at least one of an application of cosmetic products, a cosmetic procedure, a wellness procedure, a medical treatment, exposure to an environment, or aging.

18. The method of claim 15, wherein the measured effect is determined based on at least one of sensor data or expert annotation data indicating changes in measurements over time that correspond to changes in dermal features.

19. The method of claim 15, wherein the dermal change function is used to at least one of:
generate a first set of images illustrating intermediate changes between a first point in time and a second point in time; or
generate a second set of images illustrating an effect beyond the second point in time for illustrating evolution of specific modifications.

20. The method of claim 15, further comprising:
identifying product and effect data that includes ingredients of cosmetic products, concentrations thereof in the cosmetic products, and effects associated with the ingredients and the concentrations;
receiving new product information corresponding to a new product and including new product ingredients and new concentrations thereof; and
predicting a new product modification corresponding to effects of the new product on the dermal region based on the new product information and the product and effect data, wherein the target modification is the new product modification such that the adjusted image corresponds to application of the new product.

21. The method of claim 20, further comprising generating a written description of the new product modification based on the predicted new product modification.

22. The method of claim 15, further comprising:
generating a set of tags for a new agent of influence, the tags including at least one of:
dermal needs addressed by the new agent of influence,
product activity and mechanism of effect of the new agent of influence,
class solution of the new agent of influence,
category of the new agent of influence, or
frequency of application of the new agent of influence, and
providing recommendations based on the generated set of tags.

23. The method of claim 15, further comprising:
generating a new set of images of at least one of a face, skin, hair, teeth, eyelashes, or nails by applying the dermal change function to a set of base images to transfer a visual representation of dermal effects from a first group of subjects to a second group of subjects shown in the set of base images; and
using the new set of images to scale a clinical dataset by showing effects of the dermal change function which illustrates an agent of influence.

24. The method of claim 15, further comprising generating at least one of: a set of images of a subject of the image that includes the dermal region from different angles, three-dimensional (3D) objects, or videos from the adjusted image with the target modifications applied to the dermal region.
